(19) United States
(12) Patent Application Publication
(10) Pub. No.: US 2009/0028766 A1
(43) Pub. Date: Jan. 29, 2009

(54) High Purity Anhydrous Aluminium Chloride and Process for Production Thereof

(75) Inventor: Shinji Imamura, Shizuoka (JP)

Correspondence Address: BIRCH STEWART KOLASCH & BIRCH, PO BOX 747, FALLS CHURCH, VA, 22040-0747, US

(73) Assignee: Nippon Light Metal Company, Ltd., Tokyo (JP)

(21) Appl. No.: 11/887,785

(22) PCT Filed: Apr. 3, 2006
(86) PCT No.: PCT/JP2006/307048

§ 371 Date: Jan. 3, 2008

(30) Foreign Application Priority Data
Apr. 4, 2005 (JP) 2005-0107719

(51) Int. Cl. C01F 7/58

(52) U.S. Cl. 423/111; 423/495

(57) ABSTRACT

The present invention provides high purity anhydrous aluminium chloride which is freed as completely as possible from all the major impurity components (impurity metals) derived from starting aluminium used in industrial production of anhydrous aluminium chloride, wherein a content of the major impurity components except gallium (Ga), such as Na, K, Si, Fe, etc. is 1 ppm or less, and a purity of the anhydrous aluminium chloride as determined by subtracting a total content of the impurity components is 99.99% by weight or more, preferably 99.999% or more, and a process for production thereof.

### TECHNICAL FIELD

The present invention relates to high purity anhydrous aluminium chloride which is obtained by using crude anhydrous aluminium chloride produced industrially as a raw material and is extremely excellent in purity by being freed as completely as possible from impurity components (impurity metals), and a process for production thereof.

### BACKGROUND ART

Anhydrous aluminium chloride is generally used for petroleum refinery, many organic syntheses and the like as a Lewis acid catalyst. However, in recent years, it has been used for fuel cells, semiconductors and the like, and as a raw material of Al₂O₃ insulation films for Chemical Vapor Deposition (CVD) in the production of IC, ALE (atomic layer epitaxial) method in the production of EL (electroluminescence) elements and the like, and thus, high purity anhydrous aluminium chloride obtained by reducing contents of impurity components as completely as possible has been highly required. However, no anhydrous aluminium chloride satisfying this request is found even in commercially available special grade reagents.

This anhydrous aluminium chloride is industrially produced by blowing chlorine gas into a molten aluminium, generating and vaporizing an aluminium chloride vapor and solidifying the obtained aluminium chloride vapor by using a condenser.

And in anhydrous aluminium chloride industrially produced in this way, metal chlorides, such as ferric chloride (FeCl₃), etc. as impurities derived from metal aluminium used as the raw material, equipments used as production apparatuses and the like are unavoidably contaminated, and cause various problems, e.g., they stain products with yellow and harmful impurity components are contaminated in secondary products using this anhydrous aluminium chloride as the raw material.

Thus, conventionally, in order to obtain high purity anhydrous aluminium chloride, metal aluminium and the chlorine gas used as the raw materials have been previously purified, the process for production per se has been improved, and anhydrous aluminium chloride industrially produced has been purified.

For example, in JP-A-H9 (1997)-301,714, a process for producing high purity anhydrous aluminium chloride by keeping a temperature of a molten aluminium in a reactor in a given range as well as introducing chlorine gas purified by reducing a carbon dioxide content as completely as possible is described.

However, in this process, in order to produce high purity anhydrous aluminium chloride where a content of impurity components is low, it is necessary to use metal aluminium where the impurity component content is extremely low as the raw material, which is problematic in that a production cost becomes extremely high.

Also, in JP-A-2002-12,993, it is proposed to produce anhydrous aluminium chloride by electrochemically reacting metal aluminium and the chlorine gas while using a mixed molten salt bath of aluminium chloride and sodium chloride where a weight composition ratio of the aluminium chloride is 72.8% by weight.

However, in this process, even if raw materials for the production are inexpensive, the production apparatus and its operation are extremely complicated, and thus, the production cost is increased by just that much. In addition, the purity of produced anhydrous aluminium chloride is about 99.9% by weight which is not necessarily high.

Furthermore, in JP-A-H6 (1994)-1,607, it is proposed to produce high purity anhydrous aluminium chloride by forming a mixed molten salt layer composed of aluminium chloride and sodium chloride on the surface of a molten aluminium, and contacting an anhydrous aluminium chloride vapor generated by the reaction of metal aluminium and chlorine gas with the above mixed molten salt layer to wash.

However, in this process, the reaction temperature at 660° C. or above is required for the temperature of the molten aluminium, and the mixed molten salt layer is formed on the surface of this molten aluminium. Thus, it can not be avoided that the impurity components such as sodium aluminium tetrachloride (NaAlCl₄), etc. having a relatively high vapor pressure and derived from metal chlorides are contaminated. This process is not suitable for the use for fuel cells, semiconductors and the like.

Still furthermore, in JP-A-H6 (1994)-263,438, it is proposed to produce high purity anhydrous aluminium chloride at low temperature of 120° C. by using a mixed molten salt bath composed of aluminium chloride and onium chlorides.

However, in this process, it is necessary to clean up organic waste gas derived from onium chlorides, and a recovery ratio of purified anhydrous aluminium chloride to crude aluminium chloride is low. Additionally, concentrations of impurity contents such as sodium, iron and the like are about 2 ppm and 1 ppm, respectively, indicating that the product is not necessarily highly purified.

Still furthermore, in JP-A-S55 (1980)-158,121, it is proposed to purify by eliminating the impurity components such as titanium tetrachloride (TiCl₄), silicon tetrachloride (SiCl₄), ferric chloride (FeCl₃) and the like derived from metal chlorides by fractional distillation using a distillation column.

However, in this process, not only the apparatus becomes complicated but also contamination of the impurity components can not be avoided. It is difficult to obtain high purity anhydrous aluminium chloride at an extent that it can be used for the fuel cells, the semiconductors and the like.

Still furthermore, in “Basis of molten salt and thermal technology” pages 268 to 269 published by Agne Gijutsu Center on Aug. 10, 1993, the process of purifying by subliming anhydrous aluminium chloride from a bilayer of a mixed molten salt bath composed of a semi-purified aluminium chloride molten salt as an upper layer and a mixed molten salts of sodium chloride and aluminium chloride as a lower layer is described.

However, in order to make a state of the bilayer mixed molten salt bath, 90% by weight or more of aluminium chloride and a liquid temperature at 191° C. or above are required. This state can not be realized in an open system in terms of pressure, and the purification apparatus is limited to a close system. Thus, this process is experimentally easy, but is not appropriate to be employed industrially because mass production is difficult.
Patent document 1: JP-A-H9 (1997)-301,417;
Patent document 2: JP-A-2002-12,993;
Patent document 3: JP-A-H6 (1994)-1,607;
Patent document 4: JP-A-H6 (1994)-263,438;
Patent document 5: JP-A-S55 (1980)-158,121; and
Non-patent literature 1: “Basis of molten salt and thermal technology” pages 268 to 269 published by Agne Gijutsu Center on Aug. 10, 1993.

### DISCLOSURE OF THE INVENTION

### Problems to be Solved by the Invention

As a result of an extensive study on producing extremely high purity anhydrous aluminium chloride by separating and eliminating as completely as possible impurity components (impurity metals) contaminated in anhydrous aluminium chloride, the present inventor has found that anhydrous aluminium chloride can be purified to such an extent that a content of major impurity components except gallium (Ga) derived from an aluminium raw material used upon industrial production of anhydrous aluminium chloride is 1 ppm or less and a purity of anhydrous aluminium chloride as determined by subtracting the total content of the impurity components can be easily made 99.99% by weight or more, and if necessary 99.999% by weight or more industrially, by using a mixed molten salt bath composed of aluminium chloride and sodium chloride and controlling a condition for generating an anhydrous aluminum chloride vapor and a condition for condensing this generated anhydrous aluminium chloride vapor, and has completed the present invention.

Gallium (Ga) belongs to the same IIIB group in the periodic table as aluminium (Al), is an amphoteric metal which is dissolved in both acid and alkali liquids as is the case with aluminium, and its chemical nature is very similar to that of aluminium. For example, it is possible to fall this gallium as a semiconductor compound into the same lattice as aluminium. Thus, it is determined that gallium has no effect as the impurity on most of the uses. Accordingly, in the present invention, the purity of anhydrous aluminium chloride could be kept without determining its acceptable content individually.

Therefore, it is an object of the present invention to provide high purity anhydrous aluminium chloride which is freed as completely as possible from all the major impurity components (impurity metals), i.e., sodium (Na), potassium (K), lithium (Li), magnesium (Mg), silicon (Si), calcium (Ca), beryllium (Be), titanium (Ti), vanadium (V), chromium (Cr), scandium (Sc), manganese (Mn), iron (Fe), cobalt (Co), nickel (Ni), copper (Cu), zinc (Zn), gallium (Ga) and germanium (Ge) derived from starting aluminium used in the industrial production of anhydrous aluminium chloride, in which the content of the major impurity components except gallium (Ga) is 1 ppm or less and the purity of the anhydrous aluminium chloride as determined by subtracting the total content of the impurity components is 99.99% by weight or more.

It is another object of the present invention to provide high purity anhydrous aluminium chloride which is freed as completely as possible from the major impurity component derived from starting aluminium used in the industrial production of anhydrous aluminium chloride, in which the purity of the anhydrous aluminium chloride as determined by subtracting the total content of the impurity components is 99.999% by weight or more and all the major impurity components except gallium (Ga) are substantially below the detection limit.

It is another object of the present invention to provide a process for producing high purify anhydrous aluminium chloride, in which such high purity anhydrous aluminium chloride can be easily produced industrially.

### Means for Solving the Problems

That is, the present invention is high purity anhydrous aluminium chloride which is freed as completely as possible from the major impurity component (impurity metals) derived from starting aluminium used in the industrial production of anhydrous aluminium chloride, wherein the content of the major impurity components except gallium (Ga) is 1 ppm or less, and the purity of the anhydrous aluminium chloride as determined by subtracting the total content of the impurity components is 99.99% by weight or more, and preferably the purity of the anhydrous aluminium chloride as determined by subtracting the total content of the impurity components is 99.999% by weight or more.

The present invention is also the process for producing high purity anhydrous aluminium chloride produced by using a sublimation purification apparatus comprising the sublimation furnace capable of controlling the temperature which sublimes an anhydrous aluminium chloride vapor from the mixed molten salt bath and the condenser capable of controlling the temperature which is connected to this sublimation furnace and condenses the anhydrous aluminium chloride vapor, wherein a weight composition ratio of aluminium chloride in a mixed molten salt bath composed of aluminium chloride and sodium chloride is kept in the range of 90 to 98% by weight, an atmosphere temperature in a condenser is controlled at 160° C. or above when a bath temperature of the mixed molten salt bath is lower than 170° C., the atmosphere temperature in the condenser is controlled at 40 to 80° C. when the bath temperature of the mixed molten salt bath is 170 to 185° C., to collect the purified anhydrous aluminium chloride in the condenser, and the mixed molten salt bath whose bath temperature exceeds 185° C. is left as a heavy end in a sublimation furnace.

In the present invention, the chlorine compounds of impurity metal having a lower boiling point than the boiling point of anhydrous aluminium chloride can include, for example, silicon chlorides, titanium chlorides, vanadium chlorides and the like. The metal chlorides having the higher boiling point than that of anhydrous aluminium chloride can include, for example, sodium chloride, magnesium chloride, potassium chloride, ferric chloride and the like.

In high purity anhydrous aluminium chloride of the present invention, the “purity of anhydrous aluminium chloride as determined by subtracting the total content of the impurity components” means that all other than the impurity component (impurity metals) concentration detectable in an analytical process typically provided is regarded as a pure content. Such a purity of this anhydrous aluminium chloride is 99.99% by weight or more, and preferably 99.999% by weight or more.

In the process for producing high purity anhydrous aluminium chloride of the present invention, it is required that the weight composition ratio of aluminium chloride in the mixed molten salt bath is kept in the range of 90% by weight or more and 98% by weight or less, and preferably in the range of 93% by weight or more and 97% by weight or less, simultaneously the atmosphere temperature of the condenser is controlled in the range of 160° C. or above, preferably 170° C. or above and 175° C. or below when the bath temperature in the mixed molten salt bath is lower than 170° C. and preferably lower than 175° C., the atmosphere temperature of the condenser is controlled in the range of 40° C. or above and 80° C. or below and preferably in the range of 50° C. or above and 70° C. or below when the bath temperature in the mixed molten salt bath is in the range of 170° C. or above and 185° C. or below and preferably in the range of 180° C. or above and 183° C. or below, to collect the purified anhydrous aluminium chloride in the condenser, and the mixed molten salt bath whose bath temperature exceeds 185° C. and preferably 183° C. is left as the heavy end in the sublimation furnace.

When the weight composition ratio of aluminium chloride in the mixed molten salt bath is lower than 90% by weight, a generation rate of the anhydrous aluminium chloride vapor is rapidly decreased even when the bath temperature is raised to 200° C. or above, and a production rate is remarkably decreased, which is not preferable as the industrial production process. Conversely when it exceeds 98% by weight, the ratio of sodium aluminium tetrachloride which forms a liquid phase is lower than that which forms a solid phase, thus a heat transfer efficiency becomes poor, and a reaction rate suitable for the industrial production is not accomplished. When the temperature in the condenser is lower than 160° C. when the bath temperature is lower than 170° C., the impurity components such as titanium chlorides and vanadium chlorides having the lower boiling temperature than aluminium chloride are contaminated in the purified anhydrous aluminium chloride. When the atmosphere temperature in the condenser is lower than 40° C. when the bath temperature is 170 to 185° C., the purified anhydrous aluminium chloride becomes powdery and bulky. As a result, a volume production efficiency of the condenser is decreased, which is not suitable for the industrial production. When the atmosphere temperature in the condenser is higher than 80° C. when the bath temperature is 170 to 185° C., the purified anhydrous aluminium chloride becomes platy and hardens to spend time and effort for collecting from a condenser, as well as a condensation efficiency (recovery ratio) is widely decreased. Additionally when the bath temperature is lower than 170° C. when the purified anhydrous aluminium chloride is collected in the condenser, the sublimation of anhydrous aluminium chloride is stopped, and when the temperature is higher than 185° C., the content of the impurity components having a higher boiling point than that of anhydrous aluminium chloride is increased.

In the production process of the present invention, it is better to reduce ferric chloride (FeCl₃) having a vapor pressure close to that of aluminium chloride to ferrous chloride (FeCl₂) for being easily separated by adding a metal reducing agent composed of metal aluminium, metal magnesium or the like, preferably metal aluminium to the mixed molten salt bath. For the metal-aluminium used as the metal reducing agent, one having the purity of 99% by weight or more, preferably 99.9% by weight or more and having a powder shape, a thin film shape or a thin plate shape, preferably the powder shape is preferable, and is used in the range of typically 1% by weight or more and 3% by weight or less and preferably in the range of 1.5% by weight or more and 2.5% by weight or less relative to the amount of aluminium chloride placed in the sublimation furnace.

Furthermore, in the production process of the present invention, preferably aluminium chloride is newly supplied into the heavy end of unmixed molten salts left in the sublimation furnace, and the purified anhydrous aluminium chloride is repeatedly collected. By repeatedly using the unmixed molten salts left in the sublimation furnace, there is an advantage in that the recovery ratio of anhydrous aluminium chloride on sodium chloride and the metal reducing agent is increased to enhance a specific productivity.

### EFFECTS OF THE INVENTION

The high purity anhydrous aluminium chloride according to the present invention is the anhydrous aluminium chloride which is freed as completely as possible from all the major impurity components, i.e., sodium (Na), potassium (K), lithium (Li), magnesium (Mg), silicon (Si), calcium (Ca), beryllium (Be), titanium (Ti), vanadium (V), chromium (Cr), scandium (Sc), manganese (Mn), iron (Fe), cobalt (Co), nickel (Ni), copper (Cu), zinc (Zn), gallium (Ga) and germanium (Ge) derived from starting aluminium used in the industrial production of anhydrous aluminium chloride, in which the content of the major impurity components except gallium (Ga) is 1 ppm or less and the purity of the anhydrous aluminium chloride as determined by subtracting the total content of the impurity components is 99.99% by weight or more, and the purity of the anhydrous aluminium chloride if necessary as determined by subtracting the total content of the impurity components is 99.999% by weight or more, which is the high purity.

Also, according to the process for producing the high purity anhydrous aluminium chloride of the present invention, it is possible to easily produce such high purity anhydrous aluminium chloride industrially.

### BRIEF DESCRIPTION OF DRAWING

FIG. 1 is an explanatory view for illustrating a sublimation purification apparatus to which a process for producing a high purity anhydrous aluminium chloride of the present invention is applied.

### EXPLANATIONS OF LETTERS AND NUMERALS

1. Sublimation furnace, 1a. Heating apparatus, 2. Condenser, 2a. Heating/cooling apparatus, 3. Heat insulating pipe, 4. Piping.

### BEST MODES FOR CARRYING OUT THE INVENTION

Suitable embodiments of the present invention will be specifically described below based on Examples and Comparative Examples.

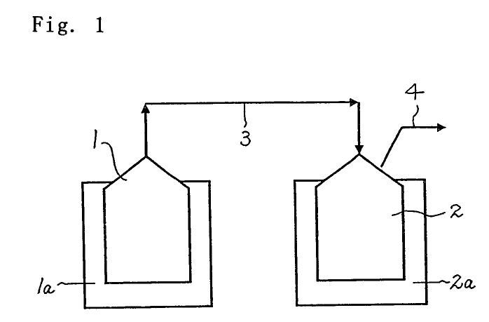

As shown in FIG. 1, a sublimation purification apparatus used in the following Examples and Comparative Examples comprises a sublimation furnace 1 capable of controlling the temperature and having a heating apparatus 1a, and a condenser 2 capable of controlling the temperature connected to this sublimation furnace 1 with a heat insulating pipe 3 to which a heat insulating treatment has been given and having a heating/cooling apparatus 2a. In the above condenser 2, a piping 4 which leads impurity components having low boiling points to an eliminating apparatus not shown in the FIGURE for trapping the impurity components having the low boiling points is provided.

### Example 1

Using the sublimation purification apparatus shown in FIG. 1, 622 g (96.1% by weight) of crude anhydrous aluminium chloride with a purity of 99% by weight and 25 g (3.9% by weight) of sodium chloride with a purity of 99% by weight were placed in its sublimation furnace 1, further 10 g of metal aluminium powder (1.6% by weight relative to anhydrous aluminium chloride) with a purity of 99.9% by weight was added thereto, the mixture was heated by setting the heating apparatus 1a at 160° C., and aluminium chloride and sodium chloride were molten to prepare a mixed molten salt bath (weight composition ratio of aluminium chloride: 96.1% by weight).

The bath temperature of the mixed molten salt bath was raised to 130° C. or above, and aluminium chloride and sodium chloride were thoroughly molten to form a liquid phase. Subsequently, the bath temperature was raised by setting the heating apparatus 1a at 195° C., the bath temperature was further raised by setting the heating apparatus 1a at 225° C. with observing the elevation of the bath temperature, and the heating by the heating apparatus 1a was stopped at the time when this bath temperature exceeded 183° C.

Meanwhile, for the condenser 2, an atmosphere temperature in the condenser 2 was controlled at 160° C. by the heating/cooling apparatus 2a until the bath temperature of the sublimation furnace 1 reached 170° C., and the atmosphere temperature in the condenser 2 was controlled at 50° C. by the heating/cooling apparatus 2a from when the bath temperature reached 170° C. until when the temperature reached 183° C. Waste gas was led to the eliminating apparatus not shown in the FIGURE using an aspirator with introducing nitrogen gas from the piping 4.

In the purified anhydrous aluminium chloride collected in the condenser 2 in this way, its weight was 185 g, its powder shape was dendritic, and concentrations of impurity components (impurity metals) were as shown in Table 1. Also, a recovery time period of the purified anhydrous aluminium chloride was one hour.

### Example 2

In the mixed molten salts in a heavy end left in the sublimation furnace 1 in the above Example 1, 200 g of the same crude anhydrous aluminium chloride as in Example 1 was placed to make the mixed molten salt bath in which the weight composition ratio of aluminium chloride was 96.2% by weight, and the crude anhydrous aluminium chloride was purified in the same way as in Example 1.

In the purified anhydrous aluminium chloride collected in the condenser 2 in this Example 2, its weight was 180 g, its powder shape was dendritic, and the concentrations of impurity components (impurity metals) were as shown in Table 1. Also, the recovery time period of the purified anhydrous aluminium chloride was one hour.

### Example 3

As was the case with the above Example 1, 630 g (96.5% by weight) of the same crude anhydrous aluminium chloride as in Example 1 and 23 g (3.5% by weight) of the same sodium chloride as in Example 1 were placed in the sublimation furnace 1, and further 12 g of a metal aluminium thin plate with a purity of 99.9% by weight (1.9% by weight relative to anhydrous aluminium chloride) was added thereto to make the mixed molten salt bath. Then, the crude anhydrous aluminium chloride was purified by performing the same heating operation of the sublimation furnace 1 and the same heating/cooling operation of the condenser 2 as in Example 1.

In the purified anhydrous aluminium chloride collected in the condenser 2 in this Example 3, its weight was 190 g, its powder shape was dendritic, and the concentrations of impurity components (impurity metals) were as shown in Table 1. Also, the recovery time period of the purified anhydrous aluminium chloride was one hour.

### Example 4

Crude anhydrous aluminium chloride was purified in the same way as in the above Example 1, except that for the condenser 2, the atmosphere temperature of the condenser 2 was controlled at 170° C. by the heating/cooling apparatus 2a until the bath temperature reached 175° C., and the atmosphere temperature of the condenser 2 was controlled at 50° C. by the heating/cooling apparatus 2a from when the bath temperature reached 175° C. until when the temperature reached 183° C.

In the purified anhydrous aluminium chloride collected in the condenser 2 in this way, its weight was 185 g, its powder shape was dendritic, and the concentrations of impurity components (impurity metals) were as shown in Table 1. Also, the recovery time period of the purified anhydrous aluminium chloride was one hour.

### Example 5

In the mixed molten salts in the heavy end left in the sublimation furnace 1 in the above Example 4, 200 g of the same crude anhydrous aluminium chloride as in Example 4 was placed to make the mixed molten salt bath in which the weight composition ratio of aluminium chloride was 96.2% by weight, and the crude anhydrous aluminium chloride was purified in the same way as in Example 4.

In the purified anhydrous aluminium chloride collected in the condenser 2 in this Example 5, its weight was 180 g, its powder shape was dendritic, and the concentrations of impurity components (impurity metals) were as shown in Table 1. Also, the recovery time period of the purified anhydrous aluminium chloride was one hour.

### Example 6

As was the case with the above Example 4, 630 g (96.5% by weight) of the same crude anhydrous aluminium chloride as in Example 1 and 23 g (3.5% by weight) of the same sodium chloride as in Example 1 were placed in the sublimation furnace 1, and further 12 g of a metal aluminium thin plate with a purity of 99.9% by weight (1.9% by weight relative to anhydrous aluminium chloride) was added thereto to make the mixed molten salt bath. Then, the crude anhydrous aluminium chloride was purified by performing the same heating operation of the sublimation furnace 1 and the same heating/cooling operation of the condenser 2 as in Example 4.

In the purified anhydrous aluminium chloride collected in the condenser 2 in this Example 6, its weight was 190 g, its powder shape was dendritic, and the concentrations of impurity components (impurity metals) were as shown in Table 1. Also, the recovery time period of the purified anhydrous aluminium chloride was one hour.

### Comparative Example 1

In the sublimation furnace 1, 495 g (94.3% by weight) of the same crude anhydrous aluminium chloride as in Example 1 and 30 g (5.7% by weight) of the same sodium chloride as in Example 1 were placed, and further 9 g of the same metal aluminium powder (1.8% by weight relative to anhydrous aluminium chloride) as in Example 1 was added thereto to prepare the mixed molten salt bath (weight composition ratio of aluminium chloride: 94.3% by weight) in the same way as in Example 1. Then, crude anhydrous aluminium chloride was purified by performing the heating operation of the sublimation furnace 1 in the same way as in Example 1, air-cooling an inside temperature of the condenser 2 to ambient temperature (20° C.) and raising it up to 80° C.

In the purified anhydrous aluminium chloride collected in the condenser 2 in this Comparative Example 1, its weight was 55 g, its powder shape was dendritic, and the concentrations of impurity components (impurity metals) were as shown in Table 1. Also, the recovery time period of the purified anhydrous aluminium chloride was one hour.

### Comparative Example 2

In the sublimation furnace 1, 580 g (95.7% by weight) of the same crude anhydrous aluminium chloride as in Example 1 and 26 g (4.3% by weight) of the same sodium chloride as in Example 1 were placed to prepare the mixed molten salt bath (weight composition ratio of aluminium chloride: 95.7% by weight) in the same way as in Example 1. Then, crude anhydrous aluminium chloride was purified in the same way as in Example 1.

In the purified anhydrous aluminium chloride collected in the condenser 2 in this Comparative Example 2, its weight was 165 g, its powder shape was dendritic, and the concentrations of impurity components (impurity metals) were as shown in Table 1. Also, the recovery time period of the purified anhydrous aluminium chloride was one hour.

### Comparative Example 3

In the sublimation furnace 1, 595 g (95.5% by weight) of the same crude anhydrous aluminium chloride as in Example 1 and 28 g (4.5% by weight) of the same sodium chloride as in Example 1 were placed, and further 10 g of the same metal aluminium powder (1.7% by weight relative to anhydrous aluminium chloride) as in Example 1 was added thereto to prepare the mixed molten salt bath (weight composition ratio of aluminium chloride: 95.5% by weight) in the same way as in Example 1. Then, crude anhydrous aluminium chloride was purified in the same way as in Example 1, except that the heating by the heating apparatus 1a was stopped at the time when the bath temperature exceeded 190° C.

In the purified anhydrous aluminium chloride collected in the condenser 2 in this Comparative. Example 3, its weight was 250 g, its powder shape was dendritic, and the concentrations of impurity components (impurity metals) were as shown in Table 1. Also, the recovery time period of the purified anhydrous aluminium chloride was one and a half hour.

TABLE 1

| Impurity | | | | | | | | | | |
|---|---|---|---|---|---|---|---|---|---|---|
| component | Analytical | Examples | | | | | | Comparative Examples | | |
| (ppm) | process | 1 | 2 | 3 | 4 | 5 | 6 | 1 | 2 | 3 |
| Na | FA | <0.1 | <0.1 | <0.1 | <0.1 | <0.1 | <0.1 | <0.1 | <0.1 | <0.1 |
| K | FA | <0.1 | <0.1 | <0.1 | <0.1 | <0.1 | <0.1 | <0.1 | <0.1 | <0.1 |
| Li | ICP | <0.05 | <0.05 | <0.05 | <0.05 | <0.05 | <0.05 | <0.05 | <0.05 | <0.05 |
| Mg | ICP | <0.05 | <0.05 | <0.05 | <0.05 | <0.05 | <0.05 | <0.05 | <0.05 | <0.05 |
| Si | AMA | <1 | <1 | 1 | <1 | <1 | 1 | 1 | 1 | 1 |
| Ca | ICP | <0.1 | <0.1 | 0.1 | <0.1 | <0.1 | 0.1 | 0.1 | 0.5 | 2.3 |
| Be | ICP | <0.05 | <0.05 | <0.05 | <0.05 | <0.05 | <0.05 | <0.05 | <0.05 | <0.05 |
| Ti | ICP | <1 | <1 | 1 | <0.5 | <0.5 | 1 | 3 | <0.5 | <0.5 |
| V | ICP | <1 | <1 | <1 | <0.1 | <0.1 | 0.4 | 1.0 | <0.1 | <0.1 |
| Cr | ICP | <0.1 | <0.1 | <0.1 | <0.1 | <0.1 | <0.1 | <0.1 | <0.1 | <0.1 |
| Sc | ICP | <0.1 | <0.1 | <0.1 | <0.1 | <0.1 | <0.1 | <0.1 | <0.1 | <0.1 |
| Mn | ICP | <0.05 | <0.05 | <0.05 | <0.05 | <0.05 | <0.05 | <0.05 | <0.05 | <0.05 |
| Fe | ICP | <0.5 | <0.5 | 0.8 | <0.5 | <0.5 | 0.8 | 1.0 | 2.1 | 3.8 |
| Co | ICP | <0.05 | <0.05 | <0.05 | <0.05 | <0.05 | <0.05 | <0.05 | <0.05 | <0.05 |
| Ni | GFAAS | <0.2 | <0.2 | <0.2 | <0.2 | <0.2 | <0.2 | <0.2 | <0.2 | <0.2 |
| Cu | GFAAS | <0.05 | <0.05 | <0.05 | <0.05 | <0.05 | <0.05 | <0.05 | <0.05 | <0.05 |
| Zn | GFAAS | <0.1 | <0.1 | <0.1 | <0.1 | <0.1 | <0.1 | <0.1 | <0.1 | <0.1 |
| Ga | ICP | <5 | <5 | 10 | <5 | <5 | 10 | 16 | 20 | 18 |
| Ge | ICP | <0.05 | <0.05 | <0.05 | <0.05 | <0.05 | <0.05 | <0.05 | <0.05 | <0.05 |

| | | | | | | | | | |
|---|---|---|---|---|---|---|---|---|---|
| Total impurity components | <9.65 | <9.65 | 14.95 | <8.25 | <8.25 | <14.35 | 23.15 | <25.25 | <26.75 |

[Note]
FA: Flame photometry
ICP: ICP mass spectrometry
AMA: Absorption spectrometry (molybdosilicic acid blue)
GFAAS: Graphitic furnace atom absorption spectrometry

### INDUSTRIAL APPLICABILITY

The high purity anhydrous aluminium chloride of the present invention is industrially useful for various intended uses where the high purity is required, including Chemical Vapor Deposition (CVD) in the production of fuel cells, semiconductors and IC, and Al₂O₃ insulation films by ALE method for EL elements, because the high purity anhydrous aluminium chloride of the present invention is freed as completely as possible from the impurity components derived from starting aluminium observed in commercially available special grade reagents and the purity of anhydrous aluminium chloride as determined by subtracting the total content of the impurity components is 99.99% by weight or more and preferably 99.999% by weight or more.

1. High purity anhydrous aluminium chloride which is freed as completely as possible from major impurity components (impurity metals) derived from starting aluminium used in industrial production of anhydrous aluminium chloride, wherein a content of the major impurity components except gallium (Ga) is 1 ppm or less, and a purity of the anhydrous aluminium chloride as determined by subtracting a total content of the impurity components is 99.99% by weight or more.

2. The high purity anhydrous aluminium chloride according to claim 1, wherein the purity of the anhydrous aluminium chloride as determined by subtracting the total content of the impurity components is 99.999% by weight or more.

3. A process for producing high purity aluminium chloride produced using a sublimation purification apparatus comprising the sublimation furnace capable of controlling the temperature which sublimates an anhydrous aluminium chloride vapor from the mixed molten salt bath and the condenser capable of controlling the temperature which is connected to this sublimation furnace and condenses the anhydrous aluminium chloride vapor, wherein a weight composition ratio of aluminium chloride in a mixed molten salt bath composed of aluminium chloride and sodium chloride is kept in a range of 90 to 98% by weight, an atmosphere temperature in a condenser is controlled at 160° C. or above when a bath temperature of the mixed molten salt bath is lower than 170° C., the atmosphere temperature in the condenser is controlled at 40 to 80° C. to collect the purified anhydrous aluminium chloride in the condenser when the bath temperature of the mixed molten salt bath is 170 to 185° C., and the mixed molten salt bath whose bath temperature exceeds 185° C. is left as a heavy end in a sublimation furnace.

4. The process for producing the high purity anhydrous aluminium chloride according to claim 3, wherein a metal reducing agent is added to the mixed molten salt bath.

5. The process for producing the high purity anhydrous aluminium chloride according to claim 4, wherein the metal reducing agent is metal aluminium or metal magnesium.

6. The process for producing the high purity anhydrous aluminium chloride according to claim 5, wherein a shape of the metal reducing agent is powdery, thin membranous or thin platy.

7. The process for producing the high purity anhydrous aluminium chloride according to any of claims 3 to 6, wherein aluminium chloride is supplied to the unmixed molten salts in the heavy end left in the sublimation furnace to repeatedly collect the purified anhydrous aluminium chloride.
